(19) United States
(12) Patent Application Publication
(10) Pub. No.: US 2017/0136738 A1
(43) Pub. Date: May 18, 2017

(54) SANDWICH METAL SHEET

(71) Applicant: NIPPON STEEL & SUMITOMO METAL CORPORATION, Tokyo (JP)

(72) Inventors: Atsuo KOGA, Tokyo (JP); Kenichiro TADOKORO, Tokyo (JP)

(73) Assignee: NIPPON STEEL & SUMITOMO METAL CORPORATION, Tokyo (JP)

(21) Appl. No.: 15/319,967

(22) PCT Filed: Jul. 14, 2015
(86) PCT No.: PCT/JP2015/070100

§ 371 Date: Dec. 19, 2016

(30) Foreign Application Priority Data
Jul. 14, 2014 (JP) 2014-144394

(51) Int. Cl. B32B 15/02; B21D 47/00; B32B 37/12; B32B 7/12; B32B 15/08; B32B 15/01

(52) U.S. Cl. CPC B32B 15/02; B32B 15/08; B32B 15/01; B32B 37/1207; B32B 7/12; B21D 47/00; B32B 2363/00; B62D 29/001

(57) ABSTRACT

[Object] To provide a novel and improved sandwich metal sheet that can improve the strength of the folded portion, moldability, and external appearance.

[Solution] Provided is a sandwich metal sheet including: a core layer including a first truss structure body and a second truss structure body in which trusses formed of frames are arranged in a matrix configuration; a first metal sheet provided on one surface of the core layer and joined to at least a vertex of the first truss structure body; and a second metal sheet provided on another surface of the core layer and joined to at least a vertex of the second truss structure body. The first truss structure body is joined to at least one of the second truss structure body and the second metal sheet, and the second truss structure body is joined to at least one of the first truss structure body and the first metal sheet.

### TECHNICAL FIELD

The present invention relates to a sandwich metal sheet.

### BACKGROUND ART

Steel sheets having a light weight, a high rigidity and a high strength, and good processability are widely demanded in various uses such as automobile members, casings of home electrical appliances, and components of office automation equipment. Further, these days, the amount of CO₂ emission is strictly regulated as a measure against global warming; in particular, in the uses of transporters (e.g. automobiles, trucks, buses, vehicles, etc.), not only is weight reduction particularly highly needed in order to reduce the amount of CO₂ emission, but also rigidity, impact resistance (collision safety), and processability are demanded at a high level. As a solution to such demands, for example as disclosed in Patent Literatures 1 to 3, a sandwich metal sheet in which a truss structure body is sandwiched by metal sheets is proposed. The sandwich metal sheet can be used as panels that form flat surfaces and curved surfaces of transporters. The truss structure body is a structure body in which trusses (cones or pyramids) formed of metal frames are arranged in a matrix configuration, and is a mechanically advantageous structural framework.

Specifically, in the technology disclosed in Patent Literature 1, a lattice body in which a lattice of tetragons or hexagons is formed is successively mountain-folded and valley-folded along diagonal lines of the lattice, and thereby a truss structure body is fabricated. Then, both surfaces of the truss structure body are sandwiched by metal sheets; thus, a sandwich metal sheet is fabricated.

In the technology disclosed in Patent Literature 2, metal wires are used to fabricate a truss structure body, and both surfaces of the truss structure body are sandwiched by metal sheets; thus, a sandwich metal sheet is fabricated.

In the technology disclosed in Patent Literature 3, a truss structure body is fabricated using a lattice body that includes a plurality of straight members arranged in a lattice configuration and contact points arranged at the points of intersection of the straight members and rotatably directing the straight members. Then, the truss structure body is sandwiched by metal sheets; thus, a sandwich metal sheet is fabricated.

### CITATION LIST

### Patent Literature

Patent Literature 1: JP 2000-120218A

Patent Literature 2: JP 2013-230593A

Patent Literature 3: JP 2001-182151A

### SUMMARY OF INVENTION

### Technical Problem

These sandwich metal sheets satisfy the demand for weight reduction; but in all of them, only one truss structure body is placed between the metal sheets, and therefore there has been a problem that, when the sandwich metal sheet is folded, a strength reduction of the folded portion, molding failure, and external appearance failure may occur. Specifically, when the sandwich metal sheet is folded, one metal sheet, that is, the metal sheet on the outside of folding experiences tensile deformation, and the other metal sheet, that is, the metal sheet on the inside of folding experiences compressive deformation. At this time, the truss cannot reinforce the metal sheet that experiences tensile deformation. This is because there is no member that reinforces the tensile deformation portion between vertices on the bottom surface side of the truss. Therefore, the tensile deformation portion stretches largely. That is, the metal sheet on the tensile deformation side deforms locally in a large degree. In association with this, the angle of the top vertex of the truss increases. Hence, the truss is squashed. That is, the folded portion (corner portion) of the sandwich metal sheet is squashed. Consequently, the strength of the folded portion may be reduced rapidly (strength reduction), and accordingly the folded portion may be broken (molding failure). Furthermore, since the sheet thickness of the folded portion is different from the sheet thickness of the other portion and the truss is squashed, the external appearance is poor (external appearance failure). When, for example, the sandwich metal sheet is used to mold a square U-shaped member like a frame of an automobile, the folded portion of the sandwich metal sheet may be squashed. If the folded portion is squashed, in addition to the problem of the external appearance failure of the corner portion of the frame, there is a possibility that a strength reduction of the frame itself will occur and impact resistance (collision safety) cannot be ensured. That is, the sandwich metal sheets disclosed in Patent Literatures 1 to 3 have not been satisfactory in any of rigidity, impact resistance (collision safety), and processability.

Thus, the present invention has been made in view of the problems mentioned above, and an object of the present invention is to provide a novel and improved sandwich metal sheet that can improve the strength of the folded portion, moldability, and external appearance.

### Solution to Problem

In order to solve the above problems, according to an aspect of the present invention, there is provided a sandwich metal sheet including: a core layer including a first truss structure body and a second truss structure body in which trusses formed of frames are arranged in a matrix configuration; a first metal sheet provided on one surface of the core layer and joined to at least a vertex of the first truss structure body; and a second metal sheet provided on another surface of the core layer and joined to at least a vertex of the second truss structure body. The first truss structure body is joined to at least one of the second truss structure body and the second metal sheet, and the second truss structure body is joined to at least one of the first truss structure body and the first metal sheet.

The frame may be formed of a metal.

At least one of the first truss structure body and the second truss structure body may be fabricated by molding a metal sheet.

At least one of the first truss structure body and the second truss structure body may be fabricated by molding a punched metal.

The frame may be formed of a resin.

Vertices of the first truss structure body may be joined to the first metal sheet and the second metal sheet, and vertices of the second truss structure body may be joined to the first metal sheet and the second metal sheet, and each of the vertices is placed between vertices of the first truss structure body.

A vertex of the second truss structure body may be placed at a center between vertices of the first truss structure body.

The sandwich metal sheet may include at least one resin layer formed on at least one of a surface on a side of the core layer of the first metal sheet and a surface on a side of the core layer of the second metal sheet.

A total thickness of the at least one resin layer may substantially coincide with a thickness of the core layer.

The at least one resin layer may be formed of a thermoplastic resin.

The second truss structure body may be stacked on the first truss structure body, and a vertex of the first truss structure body and a vertex of the second truss structure body may be joined together.

The sandwich metal sheet may include at least one resin layer formed on at least one of a surface on a side of the core layer of the first metal sheet, a surface on a side of the core layer of the second metal sheet, and a joint portion of the first truss structure body and the second truss structure body.

A total thickness of the at least one resin layer may substantially coincide with a thickness of the core layer.

The at least one resin layer may be formed of a thermoplastic resin.

At least one of a distance between vertices joined to the first metal sheet and a distance between vertices joined to the second metal sheet may be more than or equal to 0.4 times and less than or equal to 4.0 times a total thickness of the sandwich metal sheet.

At least one of a distance between vertices joined to the first metal sheet and a distance between vertices joined to the second metal sheet may satisfy the condition of Mathematical Formula (1) below,

0.57≦w/h≦3.7/α (1)

where w represents the distance between vertices joined to the first metal sheet or the distance between vertices joined to the second metal sheet, h represents a distance between the first metal sheet and the second metal sheet, and

α represents a rate of change in a joint angle of the core layer and the first metal sheet or the second metal sheet at a time of folding processing.

A joint angle of the core layer and the first metal sheet or the second metal sheet may be 60 to 150°.

According to another aspect of the present invention, there is provided a sandwich metal sheet including: a core layer including a truss structure body in which trusses formed of metal frames are arranged in a matrix configuration; a first metal sheet provided on one surface of the core layer and joined to a first vertex included in the truss structure body; a second metal sheet provided on another surface of the core layer and joined to a second vertex included in the truss structure body; and at least one resin layer formed on at least one of a surface on a side of the core layer of the first metal sheet and a surface on a side of the core layer of the second metal sheet.

### Advantageous Effects of Invention

As described above, according to the present invention, the squashing of the truss is suppressed, and accordingly the strength of the folded portion, moldability, and external appearance are improved. Consequently, the sandwich metal sheet of the present invention can improve the rigidity, impact resistance (collision safety), and processability over conventional sandwich metal sheets, while satisfying the need for weight reduction. Therefore, the sandwich metal sheet of the present invention can be used for not only panels that form flat surfaces and curved surfaces of transporters etc. but also structure members of which collision safety is demanded.

### BRIEF DESCRIPTION OF DRAWINGS

FIG. 1 is a side view schematically showing a sandwich metal sheet according to a first embodiment of the present invention.

FIG. 2 is a perspective view schematically showing a core layer.

FIG. 3 is a plan view schematically showing the core layer.

FIG. 4 is a perspective view schematically showing a truss.

FIG. 5 is a plan view schematically showing another example of the truss.

FIG. 6 is a perspective view schematically showing another example of the truss.

FIG. 7 is a perspective view schematically showing another example of the truss structure body.

FIG. 8 is a plan view illustrating a method for producing a truss structure body.

FIG. 9 is a side view schematically showing a sandwich metal sheet according to a second embodiment of the present invention.

FIG. 10 is a side view schematically showing another example of the sandwich metal sheet according to the second embodiment of the present invention.

FIG. 11 is a side view schematically showing a sandwich metal sheet according to a third embodiment of the present invention.

FIG. 12 is a side view schematically showing a sandwich metal sheet according to a fourth embodiment of the present invention.

FIG. 13 is a side view schematically showing a sandwich metal sheet according to a fifth embodiment of the present invention.

FIG. 14 is a side view illustrating the problems that a conventional sandwich metal sheet has.

### DESCRIPTION OF EMBODIMENTS

Hereinafter, (a) preferred embodiment(s) of the present invention will be described in detail with reference to the appended drawings. In this specification and the appended drawings, structural elements that have substantially the same function and structure are denoted with the same reference numerals, and repeated explanation of these structural elements is omitted.

### 1. Problems of the Background Art and an Overview of the Embodiment

The present inventors minutely investigated the problems that a conventional sandwich metal sheet has, and have found sandwich metal sheets 11 to 15 according to first to fifth embodiments. First, the problems that a conventional sandwich metal sheet has are described based on FIG. 14.

A sandwich metal sheet 100 is an example of the conventional sandwich metal sheet. The sandwich metal sheet 100 includes metal sheets 110a and 110b and a truss structure body 120 that is a core layer. The metal sheets 110a and 110b are provided on both surfaces of the truss structure body 120. The truss structure body 120 is a structure body in which trusses (cones or pyramids) 120a formed of metal frames 122 are arranged in a matrix configuration. The truss 120a may have, for example, a regular tetragonal pyramid shape. In this example, the top vertex 121a of the truss 120a is joined to the metal sheet 110a, and the vertex (hereinafter, the vertex on the bottom surface side of each truss may be referred to as a “bottom vertex”) 121b on the bottom surface 121c side is joined to the metal sheet 110b. The angle θ₇ represents the joint angle of the truss 120a and the metal sheet 110a. Here, the joint angle θ₇ of the truss 120a and the metal sheet 110a is found by the following procedure. That is, a cross section that passes through the joint point of the metal sheet 110a and the truss 120a (herein, the top vertex 121a of the truss 120a) and is perpendicular to the metal sheet 110a is defined. Then, the lines of intersection of the cross section and the truss 120a are specified, and the angle determined by the lines of intersection and the joint point is taken as the joint angle θ₇.

When, due to folding the sandwich metal sheet 100 like this, a portion (tensile deformation portion) 110c of the metal sheet 110b to which the bottom surface 121c of the truss 120a is joined experiences tensile deformation and a portion (compressive deformation portion) of the metal sheet 110a to which the top vertex 121a of the truss 120a is joined experiences compressive deformation (compressive deformation toward the surface of the metal sheet 110a), the truss 120a cannot reinforce the tensile deformation portion 110c sufficiently. This is because there is no member that reinforces the tensile deformation portion 110c between vertices 121b of the bottom surface 120c of the truss. Therefore, the tensile deformation portion 110c of the metal sheet 110b stretches largely. That is, the metal sheet 110b deforms locally in a large degree. In association with this, the joint angle θ₇ of the truss 120a becomes very large. Hence, the truss 120a is squashed. That is, the folded portion (corner portion) of the sandwich metal sheet 100 is squashed. Consequently, the strength of the folded portion may be reduced (strength reduction), and accordingly the folded portion may be broken (molding failure). Furthermore, since the sheet thickness of the folded portion is different from the sheet thickness of the other portion and the truss 120a is squashed, the external appearance is poor (external appearance failure). The present inventors minutely investigated such problems, and have found sandwich metal sheets 11 to 15 according to first to fifth embodiments.

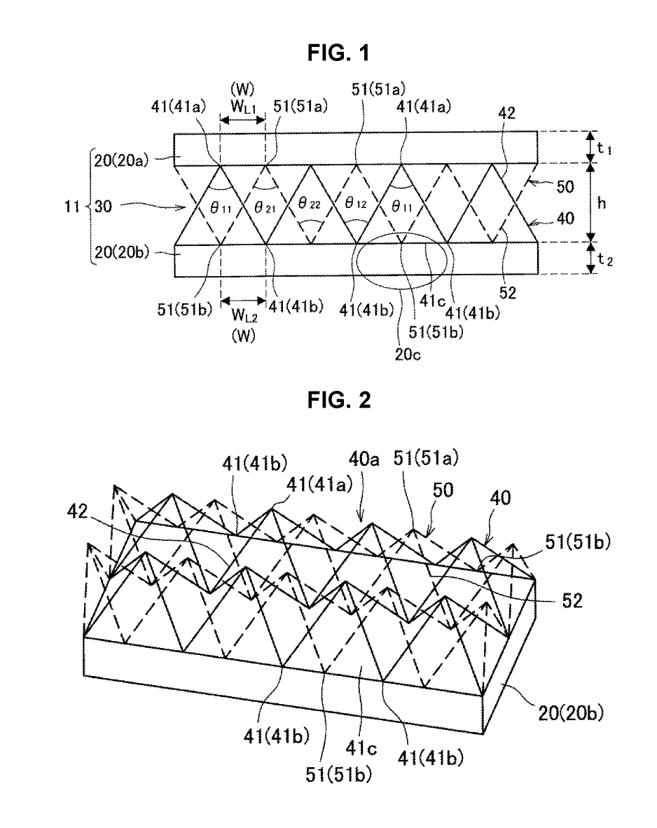

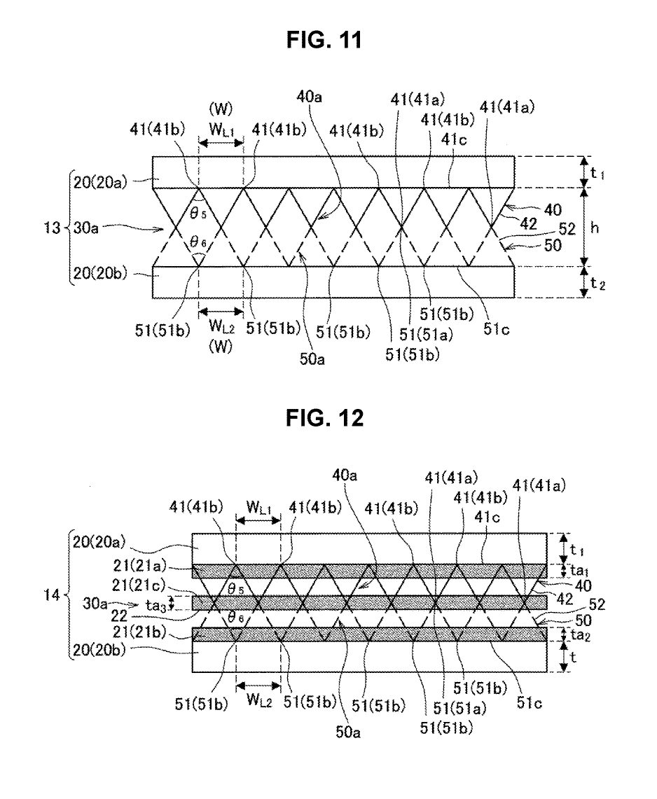

For example, as shown in FIG. 1 and FIG. 11, in the sandwich metal sheets 11 and 13 according to the first and third embodiments, a vertex 41 of a first truss structure body 40 is joined to at least a first metal sheet 20a, and a vertex 51 of a second truss structure body 50 is joined to at least a second metal sheet 20b. Further, the first truss structure body 40 is joined to at least one of the second truss structure body 50 and the second metal sheet 20b, and the second truss structure body 50 is joined to at least one of the first truss structure body 40 and the first metal sheet 20a. Therefore, the number of vertices joined per unit area of the first metal sheet 20a and the second metal sheet 20b is made larger than in the past. Thereby, the strength of the folded portion, moldability, and external appearance are improved.

For example, in the first embodiment, as shown in FIG. 1, the vertices 41 and 51 of the first truss structure body 40 and the second truss structure body 50 are joined to both of the first metal sheet 20a and the second metal sheet 20b, and the position of the vertex of the second truss structure body 50 is placed between vertices of the first truss structure body 40. Thereby, the number of vertices joined per unit area of the first metal sheet 20a and the second metal sheet 20b is made larger than in the past.

In the third embodiment, as shown in FIG. 11, the first truss structure body 40 is joined to the first metal sheet 20a, and the second truss structure body 50 is joined to the second metal sheet 20b. The top vertex 41a of the first truss structure body 40 and the top vertex 51a of the second truss structure body 50 are joined together in a core layer 30a. Therefore, the sizes of the first truss structure body 40 and the second truss structure body 50 are made smaller than the size of the conventional truss structure body, and hence the number of vertices joined per unit area of the first metal sheet 20a and the second metal sheet 20b is made larger than in the past. Each embodiment will now be described in detail.

### 2. First Embodiment

### (2-1. Overall Configuration of the Sandwich Metal Sheet>

First, an overall configuration of a sandwich metal sheet 11 according to a first embodiment is described based on FIG. 1. The sandwich metal sheet 11 includes a core layer 30 and metal sheets 20 provided on both surfaces of the core layer 30. In the embodiment, the metal sheets 20 may be distinguished by referring to one metal sheet 20 as a first metal sheet 20a and the other metal sheet 20 as a second metal sheet 20b.

### (2-2. Configuration of The Metal Sheet)

The type (material) of the metal that forms the metal sheet 20 is not particularly limited. A preferred example of the metal sheet 20 is a steel sheet, but other types of metal' sheets are possible. That is, examples of the metal that forms the metal sheet include steel, aluminum, titanium, magnesium, copper, and nickel, alloys of these, and the like. The type of the steel sheet is not particularly limited. Examples of the steel sheet that can be used in the embodiment include surface-treated steel sheets such as steel sheets for cans such as tinplate, a thin tin-plated steel sheet, an electrolytic chromic acid-treated steel sheet (tin-free steel), and a nickel-plated steel sheet, hot dipped steel sheets such as a zinc-hot-dipped steel sheet, a zinc-iron alloy-hot-dipped steel sheet, a zinc-aluminum-magnesium alloy-hot-dipped steel sheet, an aluminum-silicon alloy-hot-dipped steel sheet, and a lead-tin alloy-hot-dipped steel sheet, and electroplated steel sheets such as a zinc-electroplated steel sheet, a zinc-nickel-electroplated steel sheet, a zinc-iron alloy-electroplated steel sheet, and a zinc-chromium alloy-electroplated steel sheet, cold rolled steel sheets, hot rolled steel sheets, and stainless steel sheets. In the case where welding is not performed, the steel sheet may be a surface-treated steel sheet such as a painted steel sheet, a printed steel sheet, or a film laminated steel sheet.

The first metal sheet 20a and the second metal sheet 20b may be different from each other. Specifically, in uses in which folding processing, drawing processing, etc. are needed, the core layer 30 may be sandwiched between steel sheets with different strengths; and soft steel may be used for a surface with a small curvature radius that is hard to process, and high tensile steel or the like may be used for the other surface in order to ensure strength. A known surface treatment may be performed on the surface of the metal sheet 20 in order to improve adhesive strength or corrosion resistance. Examples of such a surface treatment include chromate treatment (reaction type, application type, and electrolysis), non-chromate treatment, phosphate treatment, organic resin treatment, and the like, but are not limited to these. Preferred thicknesses of the metal sheet 20 are 0.2 mm to 2.0 mm. If the thickness of the metal sheet 20 is less than 0.2 mm, buckling may be likely to occur during folding processing. On the other hand, if the thickness of the metal sheet 20 is more than 2.0 mm, the weight reduction effect is likely to be insufficient. From the viewpoint of weight reduction, the thickness of the metal sheet 20 is preferably 1.0 mm or less.

The thickness t₁ of the first metal sheet 20a and the thickness t₂ of the second metal sheet 20b may not be the same as long as the weight reduction effect is not impaired; one of them may be made thicker, and thereby it becomes easy to avoid the buckling and breaking of the outer layer of the steel sheet during hard processing. Preferred ratios between the thicknesses of the first metal sheet 20a and the second metal sheet 20b (the thickness t₂ of the second metal sheet 20b/the thickness t₁ of the first metal sheet 20a) are more than or equal to 0.8 and less than or equal to 1.2.

### (2-3. Configuration of the Core Layer)

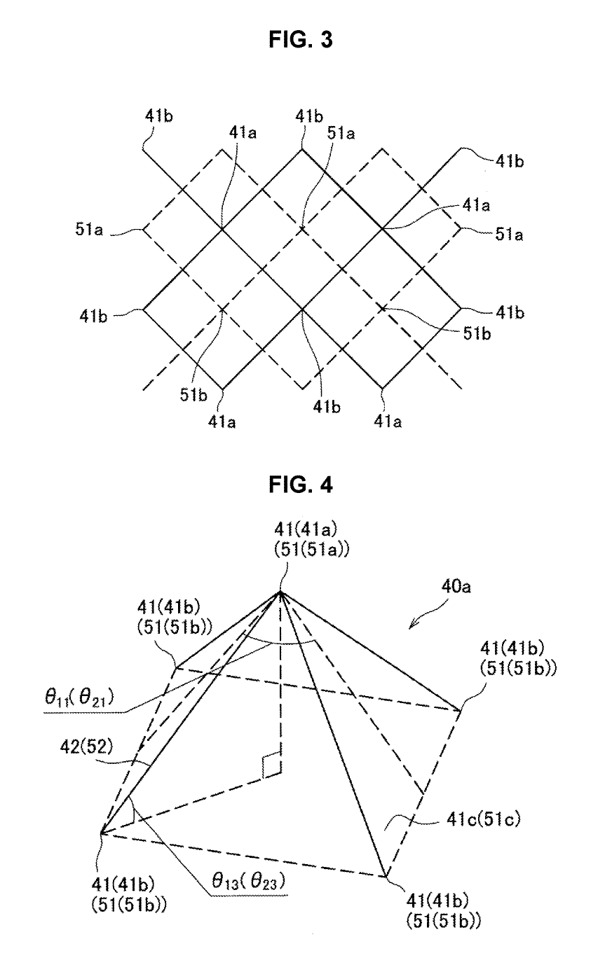

The core layer 30 includes, as shown in FIG. 2 and FIG. 3, a first truss structure body 40 and a second truss structure body 50. The first truss structure body 40 is, as shown in FIG. 2, a structure body in which trusses (cones or pyramids) 40a formed of frames 42 are arranged in a matrix configuration. The truss 40a is, as shown in FIG. 2 and FIG. 4, in a regular tetragonal pyramid shape. The truss 40a has five vertices 41. In the following description, the vertices 41 may be distinguished by referring to the top vertex as a top vertex 41a and the vertex 41 on the bottom surface side as a bottom vertex 41b.

The material that forms the frame 42 is not particularly limited. For example, the frame 42 may be formed of a similar metal to the metal sheet 20, or may be formed of a resin. Here, the resin that forms the frame 42 is not particularly limited, but is preferably a thermoplastic resin, for example. Examples of the thermoplastic resin include a general-purpose resin, a general-purpose engineering plastic, and a super engineering plastic. Examples of the general-purpose resin include polyethylene, polypropylene, polystyrene, and polyvinyl chloride. Examples of the general-purpose engineering plastic include a polyamide, a polyacetal, a polycarbonate, a modified polyphenylene ether, and a polyester. Examples of the super engineering plastic include an amorphous polyarylate, a polysulfone, a polyethersulfone, polyphenylene sulfide, a poly(ether ether ketone), a polyimide, a polyetherimide, and a fluorine resin.

Resins are inferior to metals in strength. Hence, in the case where the sandwich metal sheet 11 is used in hard processing (processing of largely folding etc.), the frame 42 is preferably formed of a metal. However, in the case where the sandwich metal sheet 11 is used for a panel member that does not need folding or a member for light processing, the frame 42 may be formed of either a metal or a resin. By forming the frame 42 out of a resin, the effects of improving the heat insulating properties and insulating properties of the sandwich metal sheet 11 and reducing the weight of the sandwich metal sheet 11 are expected. In particular, by forming the frame 42 out of a super engineering plastic, the heat resistance (e.g. heat resistance to temperature of 150° C. or more) of the sandwich metal sheet 11 is particularly improved. Further, by forming the frame 42 out of a fiber-reinforced resin (a material in which a fiber material such as carbon fibers or glass fibers is contained in the resin mentioned above), the strength of the frame 42 can be increased.

It is also possible to stack a truss structure body made of a resin on a surface of the sandwich metal sheet 11. In this case, the surface lubricity and heat insulating properties of the sandwich metal sheet 11 can be further improved.

The top vertex 41a of the truss 40a is joined to the first metal sheet 20a, and the bottom vertex 41b is joined to the second metal sheet 20b. The joint angle θ₁₁ of the truss 40a and the first metal sheet 20a is preferably 60 to 150°. This is because, when the joint angle θ₁₁ is 60 to 150°, the sandwich metal sheet 11 is resistant to shear deformation and compressive deformation in the sheet thickness direction.

The shear deformation in the embodiment refers to shear deformation occurring when force is applied in a direction parallel to the sandwich metal sheet 11, and the compressive deformation in the sheet thickness direction refers to compressive deformation occurring when force is applied in a direction perpendicular to the sandwich metal sheet 11. In the embodiment, since the frames 42 of the truss 40a are joined to the surfaces of the first metal sheet 20a and the second metal sheet 20b with inclination, the strength to shear deformation is increased. If the joint angle θ₁₁ is less than 60°, since the number of trusses 40a in the core layer 30 is increased, the mass of the sandwich metal sheet 11 is increased. Therefore, this is not preferable from the viewpoint of weight reduction. Furthermore, the resistance to shear deformation of the sandwich metal sheet 11 may be reduced. On the other hand, if the joint angle θ₁₁ is more than 150°, the sandwich metal sheet 11 may be vulnerable to compressive deformation in the sheet thickness direction. In the case where it is desired to make the sandwich metal sheet 11 resistant particularly to compressive deformation in the sheet thickness direction, the joint angle θ₁₁ may be set to 60 to 90°. In the case where it is desired to make the sandwich metal sheet 11 resistant particularly to shear deformation, the joint angle θ₁₁ may be set to more than 90° to 150°. In this case, the sandwich metal sheet 11 can be further reduced in weight. In the case where the joint angle θ₁₁ is set to approximately 150°, the sandwich metal sheet 11 may be a little vulnerable to compressive deformation in the sheet thickness direction; thus, as described in the second embodiment described later, it is preferable that a resin layer 21 be formed on the surface of the first metal sheet 20a. In this case, the joint point is reinforced by the resin layer 21, and accordingly the sandwich metal sheet 11 is made resistant to compressive deformation in the sheet thickness direction.

Here, the joint angle θ₁₁ is found by the following procedure. That is, a cross section that passes through the joint point of the first metal sheet 20a and the truss 40a (herein, the top vertex 41a of the truss 40a) and is perpendicular to the first metal sheet 20a is defined. Then, the lines of intersection of the cross section and the truss 40a are specified, and the angle determined by the lines of intersection and the joint point is taken as the joint angle θ₁₁. The magnitude of the joint angle θ₁₁ may vary depending on how to define the cross section; it is preferable that the joint angle θ₁₁ satisfy the condition prescribed in the embodiment however the cross section is defined. FIG. 4 shows an example of the joint angle θ₁₁.

Further, the joint angle θ₁₂ of the truss 40a and the second metal sheet 20b is preferably 60 to 150°. The reason is similar to the reason described in regard to the joint angle θ₁₁. In the case where it is desired to make the sandwich metal sheet 11 resistant particularly to compressive deformation in the sheet thickness direction, the joint angle θ₁₂ may be set to 60 to 90°. In the case where it is desired to make the sandwich metal sheet 11 resistant particularly to shear deformation, the joint angle θ₁₂ may be set to more than 90° to 150°. In this case, the sandwich metal sheet 11 can be further reduced in weight. In the case where the joint angle θ₁₂ is set to approximately 150°, as described in the second embodiment described later, it is preferable that a resin layer 21 be formed on the surface of the second metal sheet 20b. In this case, the joint point is reinforced by the resin layer 21.

Here, the joint angle θ₁₂ is found by the following procedure. That is, a cross section that passes through the joint point of the second metal sheet 20b and the truss 40a (herein, the bottom vertex 41b of the truss 40a) and is perpendicular to the second metal sheet 20b is defined. Then, the lines of intersection of the cross section and the truss 40a are specified, and the angle determined by the lines of intersection and the joint point is taken as the joint angle θ₁₂. The magnitude of the joint angle θ₁₂ may vary depending on how to define the cross section; it is preferable that the joint angle θ₁₂ satisfy the condition prescribed in the embodiment however the cross section is defined.

The angle θ₁₃ between the frame 42 of the truss 40a and the bottom surface 41c of the truss 40a is preferably approximately 30 to 60°, and more preferably approximately 45 to 60°. The height of the truss 40a, that is, the height (thickness) of the first truss structure body 40 is not particularly limited, but is preferably more than or equal to 1 mm and less than or equal to 5 mm in view of the processability and the like of the sandwich metal sheet 11.

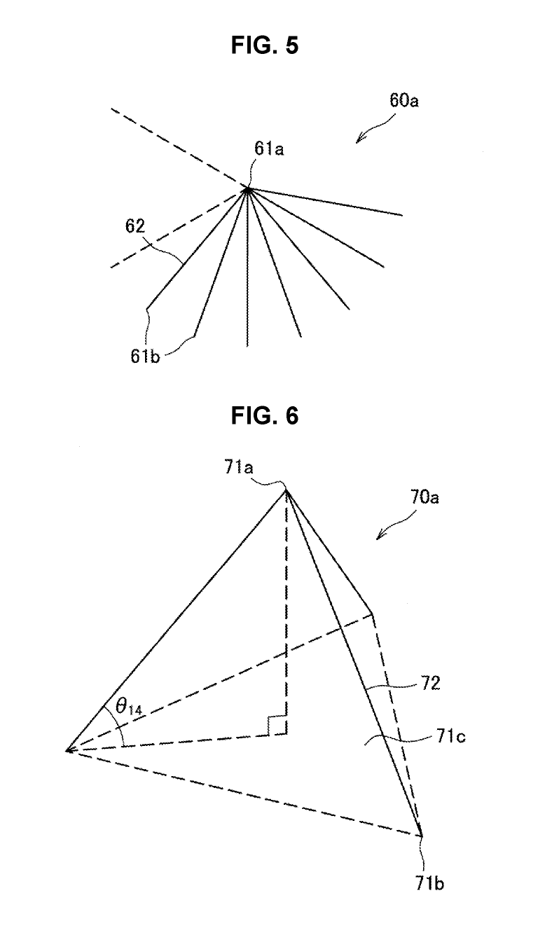

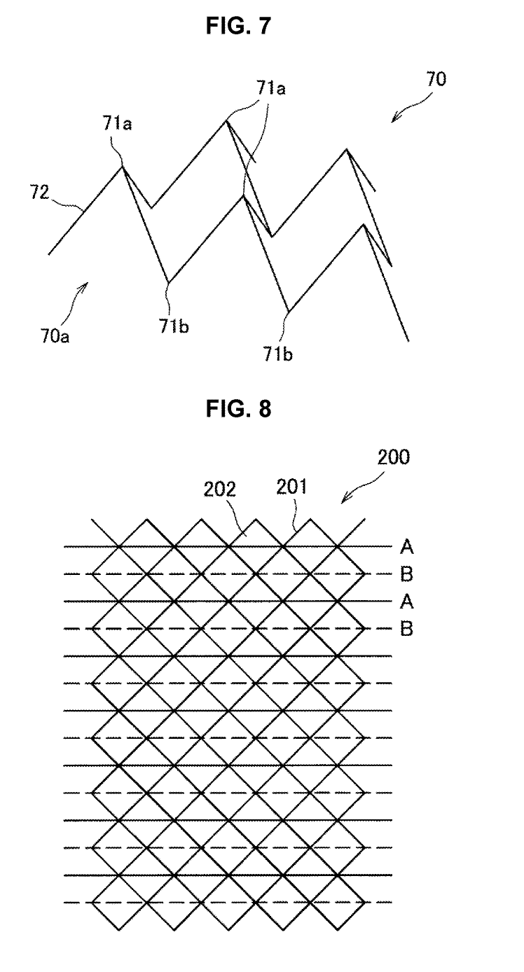

The trusses forming the first truss structure body 40 may be also an n-gonal pyramidal truss 60a shown in FIG. 5. The n-gonal pyramidal truss 60 has a top vertex 61a, bottom vertices 61b, and frames 62. When n=3, the n-gonal pyramidal truss is a trigonal pyramidal truss 70a shown in FIG. 6. The trigonal pyramidal truss 70a has a top vertex 71a, bottom vertices 71b, and frames 72. The angle θ₁₄ between the frame 72 and the bottom surface 71c of the trigonal pyramidal truss 70a is preferably approximately 30 to 60°, and more preferably approximately, 45 to 60°. This similarly applies to the n-gonal pyramidal truss 60. FIG. 7 shows a truss structure body 70 in which trigonal pyramidal trusses 70a are arranged in a matrix configuration. The most preferred shape of the truss 40a is the regular tetragonal pyramid shown in FIG. 4.

The second truss structure body 50 is, as shown in FIG. 2, a structure body in which trusses (cones or pyramids) 50a formed of frames 52 are arranged in a matrix configuration. The second truss structure body 50 has a similar configuration to the first truss structure body 40. That is, the truss 50a is, as shown in FIG. 2 and FIG. 4, in a regular tetragonal pyramid shape. The truss 50a has five vertices 51. In the following description, the vertices 51 may be distinguished by referring to the top vertex as a top vertex 51a and the vertex 51 on the bottom surface side as a bottom vertex 51b.

The material that forms the frame 52 is not particularly limited. For example, the frame 52 may be formed of a similar material to the frame 42. The effect by each material is similar to the effect described in regard to the frame 42.

The top vertex 51a of the truss 50a is joined to the first metal sheet 20a, and the bottom vertex 51b is joined to the second metal sheet 20b. The top vertex 51a is placed between top vertices 41a of the first truss structure body 40. The top vertex 51a is preferably placed at the center between top vertices 41a of the first truss structure body 40. The bottom vertex 51b is placed between bottom vertices 41b of the first truss structure body 40. The bottom vertex 51b is preferably placed at the center between bottom vertices 41b of the first truss structure body 40.

Thus, in the first embodiment, the top vertex 41a of the first truss structure body 40 and the top vertex 51a of the second truss structure 50 are joined to the first metal sheet 20a, and the bottom vertex 41b of the first truss structure body 40 and the bottom vertex 51b of the second truss structure 50 are joined to the second metal sheet 20b. The flat surface (virtual flat surface) passing through the joint points of the first truss structure body 40 and the second truss structure body 50, and the first metal sheet 20a forms one surface of the core layer 30. Further, the flat surface (virtual flat surface) passing through the joint points of the first truss structure body 40 and the second truss structure 50, and the second metal sheet 20b forms the other surface of the core layer 30. The thickness of the core layer 30 is determined as the distance between the surfaces of the core layer 30. The thickness of the core layer 30 is substantially equal to the height of the first truss structure body 40 (or the second truss structure body 50). Also in each embodiment described later, the surfaces and thickness of the core layer are similarly defined.

The joint angle θ₂₁ of the truss 50a and the first metal sheet 20a is preferably 60 to 150°. The reason is similar to the reason described in regard to the joint angle θ₁₁. In the case where it is desired to make the sandwich metal sheet 11 resistant particularly to compressive deformation in the sheet thickness direction, the joint angle θ₂₁ may be set to 60 to 90°. In the case where it is desired to make the sandwich metal sheet 11 resistant particularly to shear deformation, the joint angle θ₂₁ may be set to more than 90° to 150°. In this case, the sandwich metal sheet 11 can be further reduced in weight. In the case where the joint angle θ₂₁ is set to approximately 150°, as described in the second embodiment described later, it is preferable that a resin layer 21 be formed on the surface of the first metal sheet 20a. In this case, the joint point is reinforced by the resin layer 21.

The method for finding the joint angle θ₂₁ is similar to the method for finding the joint angle θ₁₁. That is, a cross section that passes through the joint point of the first metal sheet 20a and the truss 50a (herein, the top vertex 51a of the truss 50a) and is perpendicular to the first metal sheet 20a is defined. Then, the lines of intersection of the cross section and the truss 50a are specified, and the angle determined by the lines of intersection and the joint point is taken as the joint angle θ₂₁. The magnitude of the joint angle θ₂₁ may vary depending on how to define the cross section; it is preferable that the joint angle θ₂₁ satisfy the condition prescribed in the embodiment however the cross section is defined. FIG. 4 shows an example of the joint angle θ₂₁.

Further, the joint angle θ₂₂ of the truss 50a and the second metal sheet 20b is preferably 60 to 150°. The reason is similar to the reason described in regard to the joint angle θ₁₁. In the case where it is desired to make the sandwich metal sheet 11 resistant particularly to compressive deformation in the sheet thickness direction, the joint angle θ₂₂ may be set to 60 to 90°. In the case where it is desired to make the sandwich metal sheet 11 resistant particularly to shear deformation, the joint angle θ₂₂ may be set to more than 90° to 150°. In this case, the sandwich metal sheet 11 can be further reduced in weight. In the case where the joint angle θ₂₂ is set to approximately 150°, as described in the second embodiment described later, it is preferable that a resin layer 21 be formed on the surface of the second metal sheet 20b. In this case, the joint point is reinforced by the resin layer 21.

Here, the joint angle θ₂₂ is found by the following procedure. That is, a cross section that passes through the joint point of the second metal sheet 20b and the truss 50a (herein, the bottom vertex 51b of the truss 50a) and is perpendicular to the second metal sheet 20b is defined. Then, the lines of intersection of the cross section and the truss 50a are specified, and the angle determined by the lines of intersection and the joint point is taken as the joint angle θ₂₂. The magnitude of the joint angle θ₂₂ may vary depending on how to define the cross section; it is preferable that the joint angle θ₂₂ satisfy the condition prescribed in the embodiment however the cross section is defined.

As shown in FIG. 4, the angle θ₂₃ between the frame 52 of the truss 50a and the bottom surface of the truss 50a is preferably approximately 30 to 60°, and more preferably approximately 45 to 60°. The height of the truss 50a, that is, the height (thickness) of the second truss structure body 50 is not particularly limited, but is preferably more than or equal to 1 mm and less than or equal to 5 mm in view of the processability of the sandwich metal sheet 11, etc. The truss 50a may be the trusses shown in FIG. 5 to FIG. 6.

Thus, in the sandwich metal sheet 11 according to the first embodiment, since the vertex 51 of the second truss structure body 50 is placed between vertices 41 of the first truss structure body 40, the number of vertices in contact per unit area of the first metal sheet 20a and the second metal sheet 20b is made larger than in the past. Thereby, the strength of the folded portion, moldability, and external appearance are improved.

More specifically, as shown in FIG. 1, when, due to folding the sandwich metal sheet 11, a portion (tensile deformation portion) 20c of the second metal sheet 20b with which the bottom surface of the truss 40a is in contact experiences tensile deformation and a portion (compressive deformation portion) of the first metal sheet 20a with which the top vertex 41a of the truss 40a is in contact experiences compressive deformation (compressive deformation toward the surface of the first metal sheet 20a), the tensile deformation portion 20c is reinforced by the bottom vertex 51b placed between bottom vertices 41b of the bottom surface 41c. In other words, since the tensile deformation portion is divided by the bottom vertex 51b, local tensile deformation is suppressed. Consequently, the change in the joint angle On is suppressed. That is, the squashing of the truss 40a is suppressed. Therefore, also the squashing of the folded portion (corner portion) of the sandwich metal sheet 11 is suppressed. Consequently, the strength of the folded portion is improved, and the breaking of the folded portion is suppressed. Furthermore, since the difference between the sheet thickness of the folded portion and the sheet thickness of the other portion is reduced, the external appearance is improved. Thus, the strength of the folded portion, moldability, and external appearance are improved.

Here, the distance W_{L1} between the top vertices 41a and 51a joined to the first metal sheet 20a is preferably more than or equal to 0.4 times and less than or equal to 4.0 times and more preferably more than or equal to 1.0 time and less than or equal to 1.8 times the total thickness of the sandwich metal sheet 11 (=h+t₁+t₂, where h represents the distance between the first metal sheet 20a and the second metal sheet 20b). Similarly, the distance W_{L2} between the bottom vertices 41b and 51b joined to the second metal sheet 20b is preferably more than or equal to 0.4 times and less than or equal to 4.0 times and more preferably more than or equal to 1.0 time and less than or equal to 1.8 times the total thickness of the sandwich metal sheet 11. When the distances W_{L1} and W_{L2} between vertices are values in these ranges, the angle change of the top vertex 41a of the truss 40a is suppressed more greatly. Consequently, the strength of the folded portion is further improved, the breaking is suppressed more greatly, and the external appearance is further improved.

It is still more preferable that at least one of the distances W_{L1} and W_{L2} between vertices satisfy the condition of Mathematical Formula (1) below.

0.57≦w/h≦3.7/α (1)

In Mathematical Formula (1), w represents the distance W_{L1} or W_{L2} between vertices, h represents the distance between the first metal sheet 20a and the second metal sheet 20b, and α represents the rate of change in the joint angle during folding processing (the joint angle on the compressive deformation side). The rate of change a is calculated by the following procedure. That is, the amount of change in w at the time when the sandwich metal sheet 11 is folded with a certain curvature radius is calculated by geometric calculation, and the result is used to calculate the amount of change in the joint angle. Then, the amount of change in the joint angle is used to calculate the rate of change a. The rate of change a is expressed by Mathematical Formula (2) below.

α=tan(θ′/2)/tan(θ/2) (2)

In Mathematical Formula (2), θ′ represents the joint angle after folding processing, and θ represents the joint angle before folding processing.

In the case where, for example, the sandwich metal sheet 11 is folded with a curvature radius substantially equal to the total thickness of the sandwich metal sheet 11 (in the case of what is called hard processing), α=1.5. In the case where the sandwich metal sheet 11 is folded with a curvature radius of approximately twice the total thickness of the sandwich metal sheet 11, α=1.25. In the case where the sandwich metal sheet 11 is used as a panel member that does not need folding or is gently folded (that is, in the case of light processing), α is almost 1. Thus, the rate of change a is determined depending on how to process the sandwich metal sheet 11. There is no case where α is less than 1. This is because, while values of α of less than 1 mean that the joint angle on the compressive deformation side becomes smaller than the value before folding processing, there is no case where such an event occurs.

Further, w/h represents tan(θ/2) (θ: the joint angle on the compressive deformation side among θ₁₁ to θ₁₄). The lower limit value of 0.57 is the value of tan (60/2). That is, if w/h is less than 0.57, the number of trusses 40a in the core layer 30 is increased, and accordingly the mass of the sandwich metal sheet 11 is increased. Therefore, this is not preferable from the viewpoint of weight reduction. Furthermore, the resistance to shear deformation of the sandwich metal sheet 11 may be reduced. The upper limit value of 3.7 is the value of tan (150/2). That is, according to Mathematical Formula (2) above, it is undesirable for the joint angle after folding processing to be more than 150°. This is because, if the joint angle is more than 150°, the resistance to compressive deformation in the sheet thickness direction may be reduced.

Of the core layer 30, portions between the vertices of the first truss structure body 40 and the second truss structure body 50 form gap layer portions directly joined to the first metal sheet 20a and the second metal sheet 20b, and the compression resistance is reduced in the portions. Consequently, during the processing (for example, during the folding) of the sandwich metal sheet 11, the first metal sheet 20a or the second metal sheet 20b may cave into the gap portion of the core layer 30. Thus, from the viewpoint of preventing the caving-in of the first metal sheet 20a and the second metal sheet 20b, the distance W_{L1} between vertices is preferably less than or equal to 30 times and more preferably less than or equal to 10 times the thickness t₁ of the first metal sheet 20a. Similarly, the distance W_{L2} between vertices is preferably less than or equal to 30 times and more preferably less than or equal to 10 times the thickness t₂ of the second metal sheet 20b.

The core layer 30 and the metal sheet 20 are joined together by an adhesive. The adhesive is not particularly limited, and an adhesive used for a sandwich metal sheet in which a truss structure body is used for a core layer can be used without problems in the embodiment. However, from the viewpoint of ensuring the heat resistance and durability of the adhesive, a structural adhesive in which an epoxy resin is used as the matrix is preferable, and particularly a one-component heat-setting adhesive in which a hardener is mixed in advance is more preferable in terms of handleability. From the viewpoint of ensuring the weldability of the sandwich metal sheet 11, an electrically conductive adhesive is preferable. Examples of the electrically conductive adhesive include an adhesive in which a prescribed amount of a metal powder such as aluminum powder, nickel powder, or iron powder is added to an adhesive like that described above. The core layer 30 and the metal sheet 20 may be joined together also by brazing, seam welding, or the like.

### (2-4. Method for Producing the Truss Structure Body)

Next, a method for producing the first truss structure body 40 and the second truss structure body 50 is described. First, the case where the frames 42 and 52 are each a metal frame is described. As shown in FIG. 8, a wire net 200 is prepared. The wire net 200 is a sheet-like member in which frames 201 are distributed in a net configuration, and has a large number of openings 202. Although the opening 202 is a square in FIG. 8, the shape of the opening 202 is not limited to a square. The type of the wire net 200 is not particularly limited.

For example, the wire net 200 may be a wire net fabricated by weaving metal wires in a net configuration (hereinafter, such a wire net may be referred to as a “knitted wire net”). In this case, the metal wire forms a frame 201. The method for weaving metal wires is selected preferably with consideration of the ductility of the metal wire. For example, in the case where the ductility of the metal wire is low, the metal wire may be broken during folding processing. Hence, a wire net in which the point of intersection of a warp wire and a weft wire of the wire net (the intersection portion) is not fixed may be fabricated; thereby, displacement deformation between metal wires occurs at the point of intersection, and breaking can be prevented. Thus, in the case where the ductility of the metal wire is low, it may be inappropriate to fix the point of intersection of metal wires by welding. However, in this case, since the intersection portion of frames 201 forms the vertex of the first truss structure body 40 and the second truss structure body 50, the strength of the vertex is reduced. In the case where the point of intersection is joined by a joining material such as an adhesive, a joining material having deformability capable of withstanding displacement deformation during folding processing is preferably used because the shape of the truss structure body can be maintained while the breaking of the metal wire is prevented. However, when the angle of the mountain fold and the valley fold of the wire net 200 is set to an acute angle, there is still a high possibility that the frame 201 and the welded portion will be broken.

The wire net 200 may be also a wire net fabricated by forming a large number of punched holes in a metal sheet (what is called a punched metal). In this case, the metal portion between punched holes (what is called a “bar”) forms a frame 201. The wire net 200 may be also a wire net fabricated by forming a large number of notches in a metal sheet and then extending the metal sheet in a direction crossing the length direction of the notch (that is, expanding the notch) (what is called an expanded metal). In this case, the metal portion between expanded notches forms a frame 201. In the case where the wire net 200 is a punched metal or an expanded metal, the first truss structure body 40 and the second truss structure body 50 are fabricated by molding a metal sheet.

The wire net 200 is preferably formed of, among the knitted wire net, the punched metal, and the expanded metal mentioned above, the punched metal or the expanded metal. The wire net 200 is more preferably formed of the punched metal. The reason is as follows. That is, in the case where the wire net 200 is formed of the knitted wire net, it is necessary to knit a wire net, and therefore the production cost of the wire net 200 (the cost of the source material) is increased. In addition, since the intersection portion of frames 201 forms the vertex of the first truss structure body 40 and the second truss structure body 50, the strength of the vertex is reduced. This is because the frames 201 forming a vertex may shift from each other. As a method to solve the problem, it may be possible to weld the intersection portion of frames 201. However, in the case where the intersection portion of frames 201 is welded, when the wire net 200 is alternately mountain-folded and valley-folded, the frame 201 and the welded portion may be broken. In particular, when the angle of the mountain fold and the valley fold is set to an acute angle, the frame 201 and the welded portion are highly likely to be broken.

On the other hand, the punched metal and the expanded metal are fabricated by simply molding a metal sheet, and are therefore lower in production cost than the knitted wire net. In addition, the strength of the vertex is ensured.

Furthermore, in the case where the wire net 200 is formed of the punched metal, various shapes of punched metal can be fabricated by simply changing the structure (shape, thickness, size, etc.) of the hole of the punching of the metal sheet. Consequently, the first truss structure body 40 and the second truss structure body 50 with various shapes can be fabricated at low cost. Furthermore, in the case where the wire net 200 is formed of the punched metal, the intersection portion of frames 201 is flat, and therefore the strength of the vertex is improved. On the other hand, the expanded metal is formed by forming notches in a metal sheet and then extending the metal sheet. Therefore, concavity and convexity are formed in the intersection portion of frames 201. Since the intersection portion forms the vertex of the first truss structure body 40 and the second truss structure body 50, the strength of the vertex may be slightly reduced. As a method to lessen such concavity and convexity, a method of pressing the expanded metal may be possible; but this method needs an additional step of pressing, and leads to an increase in production cost. In addition, due to the pressing of the expanded metal, processing strain occurs in the concave-convex portion of the expanded metal. Consequently, during truss molding, the concave-convex portion, that is, the portion that forms each of the vertices 41 and 51 of the first truss structure body 40 and the second truss structure body 50 may be broken (for example, the vertices 41 and 51 or their vicinity may be cracked). If the sandwich metal sheet 11 is fabricated using a cracked truss structure body, the following problem may arise. That is, when shear force is applied to the sandwich metal sheet 11, stress may be concentrated in the cracked portion, and the frame of the truss structure body may be completely cut from the cracked portion. Thus, in the case where the first truss structure body 40 and the second truss structure body 50 are fabricated using the expanded metal, as described in the second embodiment, the joint points of the first truss structure body 40 and the second truss structure body 50, and the first metal sheet 20a and the second metal sheet 20b may be protected with a resin layer 21. Thereby, even when either or both of the first truss structure body 40 and the second truss structure body 50 are cracked, the cracked portion can be buried in the resin layer 21. In this case, even when shear force is applied to the sandwich metal sheet 11, it is less likely that stress will be concentrated in the cracked portion. Consequently, the cutting of the frames 42 and 52 is suppressed.

Subsequently, the wire net 200 is alternately mountain-folded and valley-folded at straight lines A and B (straight lines connecting diagonal lines of the openings 202); thus, the first truss structure body 40 and the second truss structure body 50 are fabricated. By this method, it is possible to fabricate a first truss structure body 40 and a second truss structure body 50 in which the trusses 40a and 50a are in a trigonal pyramid shape, a regular tetragonal pyramid shape, or a tetragonal pyramid shape.

In the case where the frames 42 and 52 are each a resin frame, a mold of the first truss structure body 40 and the second truss structure body 50 may be prepared, and the mold may be used to fabricate the first truss structure body 40 and the second truss structure body 50.

### (2-5. Method for Producing the Sandwich Metal Sheet)

Next, the first truss structure body 40 and the second truss structure body 50 are superimposed so that the vertex 51 of the second truss structure body 50 is placed between vertices 41 of the first truss structure body 40. Thereby, the core layer 30 is fabricated. Subsequently, an adhesive is applied to both surfaces of the core layer 30, and the metal sheet 20 is adhered to both surfaces of the core layer 30. The adhesion is performed by applying pressure to the metal sheet 20 toward the core layer 30 side at normal temperature or in a heated condition. Thereby, the sandwich metal sheet 11 is fabricated.

Thus, by the first embodiment, the vertex 51 of the second truss structure body 50 is placed between vertices 41 of the first truss structure body 40; hence, when, for example, the portion to which the bottom surface 41c of the truss 40a is joined (the tensile deformation portion) experiences tensile deformation, the tensile deformation portion is reinforced by the vertex 51 of the second truss structure body 50. Therefore, the squashing of the truss 40a is suppressed, and accordingly the strength of the folded portion, moldability, and external appearance are improved. Consequently, the sandwich metal sheet of the present invention can improve the rigidity, impact resistance (collision safety), and processability over conventional sandwich metal sheets, while satisfying the need for weight reduction. Therefore, the sandwich metal sheet of the present invention can be used for not only panels that form flat surfaces and curved surfaces of transporters etc. but also structure members of which collision safety is demanded.

### 3. Second Embodiment

### (3-1. Overall Configuration of the Sandwich Metal Sheet

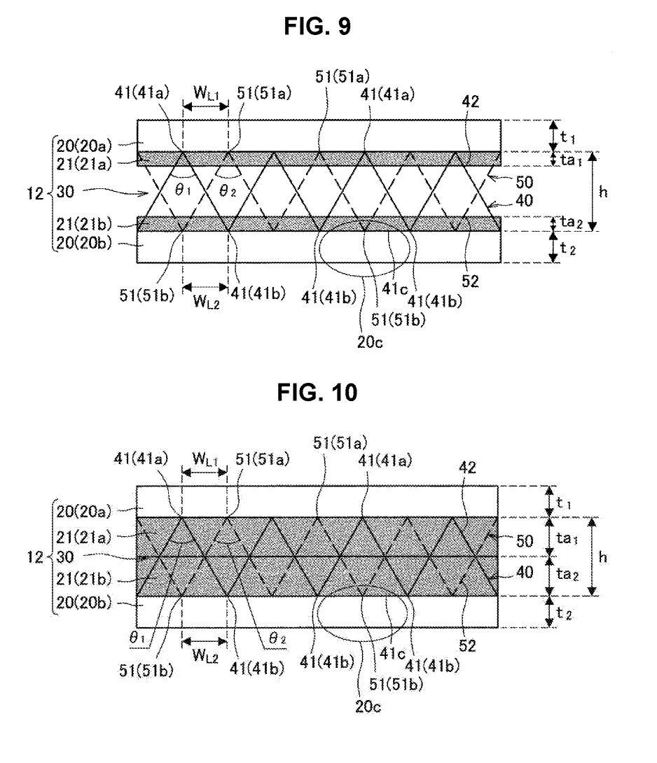

Next, a second embodiment is described based on FIG. 9 and FIG. 10. A sandwich metal sheet 12 according to the second embodiment is a sandwich metal sheet in which a resin layer 21 is added to the sandwich metal sheet 11 according to the first embodiment.

Specifically, the resin layer 21 is provided on each of a surface of the first metal sheet 20a (the surface on the core layer 30 side) and a surface of the second metal sheet 20b (the surface on the core layer 30 side). In the embodiment, the resin layers 21 may be distinguished by referring to the resin layer 21 on the first metal sheet 20a as a first resin layer 21a and the resin layer 21 on the second metal sheet 20b as a second resin layer 21b. Either one of the first resin layer 21a and the second resin layer 21b may be omitted.

The vertices of the first truss structure body 40 and the second truss structure body 50 have sunk in the resin layer 21, and are joined to the first metal sheet 20a and the second metal sheet 20b. Thus, in the second embodiment, the joint points of the first truss structure body 40 and the second truss structure body 50, and the first metal sheet 20a and the second metal sheet 20b are protected by the resin layer 21.

The type of the resin that forms the resin layer 21 is not particularly limited, but is preferably a thermoplastic resin in terms of processing etc. Examples of the thermoplastic resin include a general-purpose resin, a general-purpose engineering plastic, and a super engineering plastic. Examples of the general-purpose resin include polyethylene, polypropylene, polystyrene, and polyvinyl chloride. Examples of the general-purpose engineering plastic include a polyamide, a polyacetal, a polycarbonate, a modified polyphenylene ether, and a polyester. Examples of the super engineering plastic include an amorphous polyarylate, a polysulfone, a polyethersulfone, polyphenylene sulfide, a poly(ether ether ketone), a polyimide, a polyetherimide, and a fluorine resin.

By forming the resin layer 21 out of the thermoplastic resin described above, the joint point can be reinforced. Specifically, the peel strength between the first truss structure body 40 and the second truss structure body 50, and the first metal sheet 20a and the second metal sheet 20b can be improved. The resin layer 21 functions also as an adhesive that joins the first truss structure body 40 and the second truss structure body 50, and the first metal sheet 20a and the second metal sheet 20b. Therefore, in the second embodiment, it becomes possible to eliminate the need for the adhesive used in the first embodiment. Furthermore, the first metal sheet 20a and the second metal sheet 20b, and the first truss structure body 40 and the second truss structure body 50 can be joined by simply forming the resin layer 21 on the surfaces of the first metal sheet 20a and the second metal sheet 20b. Therefore, the productivity of the sandwich metal sheet 12 is improved.

When the resin layer 21 is formed of a general-purpose engineering plastic or a super engineering plastic, further reinforcement effect is obtained. Specifically, the deformation of the vertex of the first truss structure body 40 and the second truss structure body 50 can be suppressed. Therefore, when the sandwich metal sheet 12 is folded, the strength of the folded portion can be further improved. Further, when the resin layer 21 is formed of a super engineering plastic, the heat resistance (e.g. heat resistance to temperature of 150° C. or more) of the sandwich metal sheet 12 is improved. The resin that forms the resin layer 21 may be either a foam material or a bulk material.

The thickness ta₁ of the first resin layer 21a and the thickness ta₂ of the second resin layer 21b are not particularly limited. However, as shown in FIG. 10, the sum total of the thicknesses ta₁ and ta₂ (i.e. the total thickness of the resin layers 21) may be made to substantially coincide with the distance between the first metal sheet 20a and the second metal sheet 20b (=h).

By making the total thickness of the resin layers 21 substantially coincide with the distance between the first metal sheet 20a and the second metal sheet 20b, the strength of the sandwich metal sheet 12 to compressive deformation in the sheet thickness direction can be further improved. Here, also a sandwich metal sheet in which the space between the first metal sheet 20a and the second metal sheet 20b is filled only with resin has a large strength to compressive deformation. However, this sandwich metal sheet has very weak strength to shear deformation. This is because the interfaces between the first metal sheet 20a and the second metal sheet 20b, and the resin layer are flat. On the other hand, in the sandwich metal sheet 12 according to the second embodiment, a large number of joint points described above are formed at the interfaces between the first metal sheet 20a and the second metal sheet 20b, and the resin layer. Furthermore, the frames 42 and 52 of the first truss structure body 40 and the second truss structure body 50 are joined to the surfaces of the first metal sheet 20a and the second metal sheet 20b with inclination. Therefore, the sandwich metal sheet 12 also has a large strength to shear deformation. Furthermore, the first metal sheet 20a and the second metal sheet 20b are held by not only the first truss structure body 40 and the second truss structure body 50 but also the resin layer 21. Hence, the first metal sheet 20a and the second metal sheet 20b are less likely to shift in the thickness direction of the sandwich metal sheet 11 (less likely to sink in the thickness direction) during the cutting of the sandwich metal sheet 11.

### (3-2. Method for Producing the Sandwich Metal Sheet)

The sandwich metal sheet 12 can be fabricated by the following steps. First, the core layer 30 is fabricated by similar steps to the first embodiment. Subsequently, a resin sheet is stacked on the surface of the first metal sheet 20a, and thereby the first resin layer 21a is formed on the surface of the first metal sheet 20a. Similar steps are performed to form the second resin layer 21b on the surface of the second metal sheet 20b. Subsequently, the first resin layer 21a and the second resin layer 21b are subjected to heating or the like to soften the first resin layer 21a and the second resin layer 21b. Subsequently, the core layer 30, and the first metal sheet 20a and the second metal sheet 20b are joined. At this time, the first truss structure body 40 and the second truss structure body 50 push aside the first resin layer 21a and the second resin layer 21b, and come into contact with the first metal sheet 20a and the second metal sheet 20b. After that, the first resin layer 21a and the second resin layer 21b are subjected to cooling or the like to harden the first resin layer 21a and the second resin layer 21b. Thereby, the first truss structure body 40 and the second truss structure body 50 are joined to the first metal sheet 20a and the second metal sheet 20b. That is, the first resin layer 21a and the second resin layer 21b function as an adhesive. However, from the viewpoint of further ensuring joining strength, a joining method similar to the method of the first embodiment may be further performed.

### 4. Third Embodiment

### (4-1. Overall Configuration of the Sandwich Metal Sheet)

Next, a third embodiment is described based on FIG. 11. A sandwich metal sheet 13 according to the third embodiment is a sandwich metal sheet in which the core layer 30 of the sandwich metal sheet 11 according to the first embodiment is replaced with a core layer 30a.

The core layer 30a is a structure in which the first truss structure body 40 and the second truss structure body 50 are stacked. The top vertex 41a of the first truss structure body 40 is joined to the top vertex 51a of the second truss structure body 50, and the bottom vertex 41b of the first truss structure body 40 is joined to the first metal sheet 20a. On the other hand, the bottom vertex 51b of the second truss structure body 50 is joined to the second metal sheet 20b. The first truss structure body 40 and the second truss structure body 50 are joined together by the adhesive described above (or brazing, seam welding, or the like). Although the shapes of the first truss structure body 40 and the second truss structure body 50 are the same in FIG. 11, they may be different from each other.

When the sandwich metal sheet 13 and the conventional sandwich metal sheet 100 are compared with the same total thickness, the size of the first truss structure body 40 and the second truss structure body 50 (specifically, the size of the trusses 40a and 50a forming the first truss structure body 40 and the second truss structure body 50) is smaller than the size of the conventional truss structure body (in the example of FIG. 11, half of the conventional one). Therefore, the number of vertices 41 and 51 joined per unit area of the first metal sheet 20a and the second metal sheet 20b is made larger than in the past, and thus the strength of the folded portion, moldability, and external appearance of the sandwich metal sheet 11 are improved.

Here, the joint angle θ₅ of the truss 40a and the first metal sheet 20a is preferably 60 to 150°. The reason is similar to the reason described in regard to the joint angle θ₁₁. In the case where it is desired to make the sandwich metal sheet 13 resistant particularly to compressive deformation in the sheet thickness direction, the joint angle θ₅ may be set to 60 to 90°. In the case where it is desired to make the sandwich metal sheet 13 resistant particularly to shear deformation, the joint angle θ₅ may be set to more than 90° to 150°. In this case, the sandwich metal sheet 13 can be further reduced in weight. In the case where the joint angle θ₅ is set to approximately 150°, as described in the fourth embodiment described later, it is preferable that a resin layer 21 be formed on the surface of the first metal sheet 20a. In this case, the joint point is reinforced by the resin layer 21.

Here, the joint angle θ₅ is found by the following procedure. That is, a cross section that passes through the joint point of the first metal sheet 20a and the truss 40a (herein, the bottom vertex 41b of the truss 40a) and is perpendicular to the first metal sheet 20a is defined. Then, the lines of intersection of the cross section and the truss 40a are specified, and the angle determined by the lines of intersection and the joint point is taken as the joint angle θ₅. The magnitude of the joint angle θ₅ may vary depending on how to define the cross section; it is preferable that the joint angle θ₅ satisfy the condition prescribed in the embodiment however the cross section is defined.

The joint angle θ₆ of the truss 50a and the second metal sheet 20b is preferably 60 to 150°. The reason is similar to the reason described in regard to the joint angle θ₁₁. In the case where it is desired to make the sandwich metal sheet 13 resistant particularly to compressive deformation in the sheet thickness direction, the joint angle θ₆ may be set to 60 to 90°. In the case where it is desired to make the sandwich metal sheet 13 resistant particularly to shear deformation, the joint angle θ₆ may be set to more than 90° to 150°. In this case, the sandwich metal sheet 13 can be further reduced in weight. In the case where the joint angle θ₆ is set to approximately 150°, as described in the fourth embodiment described later, it is preferable that a resin layer 21 be formed on the surface of the second metal sheet 20b. In this case, the joint point is reinforced by the resin layer 21.

Here, the joint angle θ₆ is found by the following procedure. That is, a cross section that passes through the joint point of the second metal sheet 20b and the truss 50a (herein, the bottom vertex 51b of the truss 50a) and is perpendicular to the second metal sheet 20b is defined. Then, the lines of intersection of the cross section and the truss 50a are specified, and the angle determined by the lines of intersection and the joint point is taken as the joint angle θ₆. The magnitude of the joint angle θ₆ may vary depending on how to define the cross section; it is preferable that the joint angle θ₆ satisfy the condition prescribed in the embodiment however the cross section is defined.

Here, the distance W_{L1} between bottom vertices 41b joined to the first metal sheet 20a is preferably more than or equal to 0.4 times and less than or equal to 4.0 times and more preferably more than or equal to 1.0 time and less than or equal to 1.8 times the total thickness of the sandwich metal sheet 11. Similarly, the distance W_{L2} between bottom vertices 51b joined to the second metal sheet 20b is preferably more than or equal to 0.4 times and less than or equal to 4.0 times and more preferably more than or equal to 1.0 time and less than or equal to 1.8 times the total thickness of the sandwich metal sheet 11. When the distances W_{L1} and W_{L2} between vertices are values in these ranges, the strength of the folded portion, moldability, and external appearance of the sandwich metal sheet 13 are further improved.

It is more preferable that at least one of the distances W_{L1} and W_{L2} between vertices satisfy the condition of Mathematical Formula (1) described above. From the viewpoint of preventing the caving-in of the first metal sheet 20a and the second metal sheet 20b, the distance W_{L1} between vertices is preferably less than or equal to 30 times and more preferably less than or equal to 10 times the thickness t₁ of the first metal sheet 20a. Similarly, the distance W_{L2} between vertices is preferably less than or equal to 30 times and more preferably less than or equal to 10 times the thickness t₂ of the second metal sheet 20b.

### (4-2. Method for Producing the Sandwich Metal Sheet)

The sandwich metal sheet 13 can be fabricated by the following steps. First, the first truss structure body 40 and the second truss structure body 50 are fabricated by similar steps to the first embodiment. Then, the top vertex 41a of the first truss structure body 40 and the top vertex 51a of the second truss structure body 50 are joined together, and thereby the core layer 30a is fabricated. The method for joining may be similar to the method for joining the first metal sheet 20a and the second metal sheet 20b, and the core layer 30. After that, similar steps to the first embodiment are performed; thus, the sandwich metal sheet 13 is fabricated.

### 5. Fourth Embodiment

### (5-1. Overall Configuration of the Sandwich Metal Sheet>

Next, a fourth embodiment is described based on FIG. 12. A sandwich metal sheet 14 according to the fourth embodiment is a sandwich metal sheet in which a resin layer 21 is added to the sandwich metal sheet 13 according to the third embodiment.

Specifically, the resin layer 21 is provided on each of a surface of the first metal sheet 20a (the surface on the core layer 30 side), a surface of the second metal sheet 20b (the surface on the core layer 30 side), and the joint portion of the first truss structure body 40 and the second truss structure body 50. In the embodiment, the resin layers 21 may be distinguished by referring to the resin layer 21 on the first metal sheet 20a as a first resin layer 21a, the resin layer 21 on the second metal sheet 20b as a second resin layer 21b, and the resin layer 21 on the joint portion of the first truss structure body 40 and the second truss structure body 50 as a third resin layer 21c. Any one of the first resin layer 21a, the second resin layer 21b, and the third resin layer 21c may be omitted.

The bottom vertices 41b and 51b of the first truss structure body 40 and the second truss structure body 50 have sunk in the first resin layer 21a and the second resin layer 21b, and are joined to the first metal sheet 20a and the second metal sheet 20b. Further, the top vertices 41a and 51a of the first truss structure body 40 and the second truss structure body 50 have sunk in the third resin layer 21c, and are joined to each other. Thus, in the fourth embodiment, the joint points of the first truss structure body 40 and the second truss structure body 50, and the first metal sheet 20a and the second metal sheet 20b are protected by the first resin layer 21a and the second resin layer 21b. Further, also the joint point of the first truss structure body 40 and the second truss structure body 50 is protected by the third resin layer 21c.

The resin that forms the resin layer 21 is not particularly limited, and the resin layer 21 may be formed of a similar resin to the second embodiment. In this case, a similar effect to the second embodiment is obtained. Furthermore, an adhesive for joining the first truss structure body 40 and the second truss structure body 50 together is not needed. Furthermore, the peel strength between the first truss structure body 40 and the second truss structure body 50 can be improved. Moreover, the first truss structure body 40 and the second truss structure body 50 can be joined together by simply forming the third resin layer 21c on the top vertices 41a of the first truss structure body 40. Therefore, the productivity of the sandwich metal sheet 14 is improved.

The thickness ta₁ of the first resin layer 21a, the thickness ta₂ of the second resin layer 21b, and the thickness ta₃ of the third resin layer 21c are not particularly limited. However, the sum total of the thicknesses ta₁, ta₂, and ta₃ (the total thickness of the resin layers 21) may be made to substantially coincide with the distance between the first metal sheet 20a and the second metal sheet 20b. By making the total thickness of the resin layers 21 substantially coincide with the distance between the first metal sheet 20a and the second metal sheet 20b, the strength of the sandwich metal sheet 12 to compressive deformation in the sheet thickness direction can be further improved. Furthermore, the first metal sheet 20a and the second metal sheet 20b are held by not only the first truss structure body 40 and the second truss structure body 50 but also the resin layer 21. Hence, the first metal sheet 20a and the second metal sheet 20b are less likely to shift in the thickness direction of the sandwich metal sheet 15 (less likely to sink in the thickness direction) during the cutting of the sandwich metal sheet 15.

### (5-2. Method for Producing the Sandwich Metal Sheet)

The sandwich metal sheet 14 can be fabricated by the following steps. First, the first truss structure body 40 and the second truss structure body 50 are fabricated by similar steps to the first embodiment. Then, the top vertex 41a of the first truss structure body 40 and the top vertex 51a of the second truss structure body 50 are joined together, and thereby the core layer 30a is fabricated. Specifically, a resin sheet is stacked on the top vertices 41a of the first truss structure body 40. Subsequently, heating or the like is performed to soften the resin sheet. Subsequently, the second truss structure body 50 is pushed from on the resin sheet to the first truss structure body 40, and thereby the top vertex 41a of the first truss structure body 40 and the top vertex 51a of the second truss structure body 50 are brought into contact. Subsequently, the resin sheet is subjected to cooling or the like to harden the resin sheet. Thereby, the first truss structure body 40 and the second truss structure body 50 are joined to each other. The resin sheet forms the third resin layer 21c. However, from the viewpoint of further ensuring joining strength, a joining method similar to the method of the first embodiment may be further performed. After that, similar steps to the third embodiment are performed; thus, the sandwich metal sheet 14 is fabricated.

### 6. Fifth Embodiment

### (6-1. Overall Configuration of the Sandwich Metal Sheet>

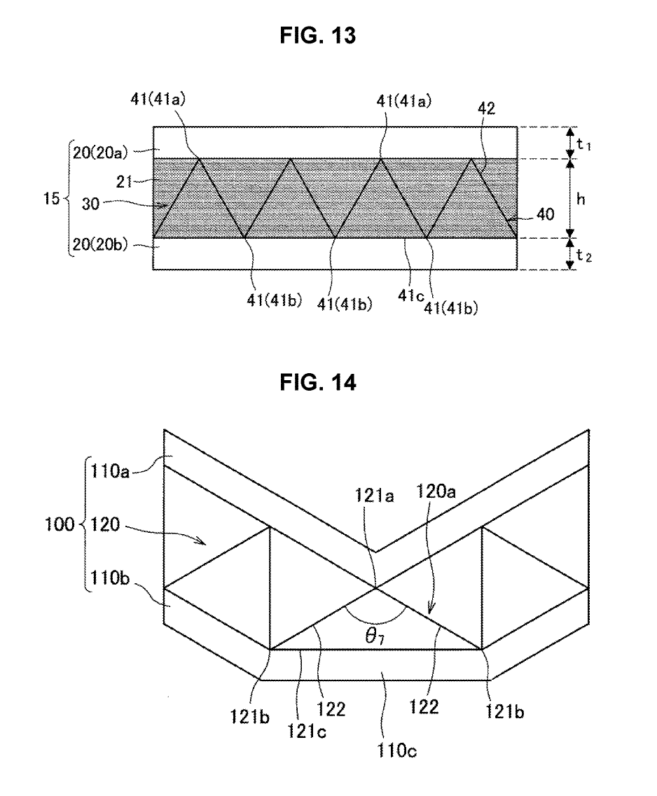

Next, a fifth embodiment is described based on FIG. 13. A sandwich metal sheet 15 according to the fifth embodiment is a sandwich metal sheet in which the core layer 30 is formed only of the first truss structure body 40 and the space between the first metal sheet 20a and the second metal sheet 20b is filled with a resin layer 21. That is, in the fifth embodiment, the first metal sheet 20a is joined to the top vertex 41a of the first truss structure body 40 (a first vertex), and the second metal sheet 20b is joined to the bottom vertex 41b of the first truss structure body 40 (a second vertex). The resin layer 21 is provided on the surfaces on the core layer 30 side of the first metal sheet 20a and the second metal sheet 20b.

The resin that forms the resin layer 21 is not particularly limited, and the resin layer 21 may be formed of a similar resin to the second embodiment. The thickness of the resin layer 21, however, substantially coincides with the distance between the first metal sheet 20a and the second metal sheet 20b (=h). In the fifth embodiment, the strengths to shear deformation and compressive deformation in the sheet thickness direction are larger than in a sandwich metal sheet in which the space between the first metal sheet 20a and the second metal sheet 20b is filled only with resin. However, since the number of truss structure bodies is small, the strengths to shear deformation and compressive deformation in the sheet thickness direction are smaller than in the sandwich metal sheet 12 shown in FIG. 10.

Further, the first metal sheet 20a and the second metal sheet 20b are held not only by the first truss structure body 40 but also by the resin layer 21. Hence, the first metal sheet 20a and the second metal sheet 20b are less likely to shift in the thickness direction of the sandwich metal sheet 15 (less likely to sink in the thickness direction) during the cutting of the sandwich metal sheet 15.

Although in the example of FIG. 13 the thickness of the resin layer 21 substantially coincides with the distance between the first metal sheet 20a and the second metal sheet 20b (=h), the thickness of the resin layer 21 may also be smaller than the distance between the first metal sheet 20a and the second metal sheet 20b (=h). In this case, the resin layer 21 is formed on each (or either one) of the surface of the first metal sheet 20a and the surface of the second metal sheet 20b, and the total thickness of the resin layer(s) 21 is smaller than the distance between the first metal sheet 20a and the second metal sheet 20b (=h).

### (6-2. Method for Producing the Sandwich Metal Sheet)

The sandwich metal sheet 15 can be fabricated by the following steps. First, the first truss structure body 40 is fabricated by similar steps to the first embodiment. Subsequently, a resin sheet is stacked on the surface of the first metal sheet 20a, and thereby the resin layer 21 (the first resin layer 21a) is formed on the surface of the first metal sheet 20a. Similar steps are performed to form the resin layer 21 (the second resin layer 21b) on the surface of the second metal sheet 20b. Here, the total thickness of the first resin layer 21a and the second resin layer 21b substantially coincides with the distance between the first metal sheet 20a and the second metal sheet 20b h). It is also possible to form the resin layer 21 only on the surface of the first metal sheet 20a (or the second metal sheet 20b) and make the thickness of the resin layer 21 substantially coincide with the distance between the first metal sheet 20a and the second metal sheet 20b (=h). The total thickness of the resin layer(s) 21 may also be smaller than the distance between the first metal sheet 20a and the second metal sheet 20b (=h).

Subsequently, the first resin layer 21a and the second resin layer 21b are subjected to heating or the like to soften the first resin layer 21a and the second resin layer 21b. Subsequently, the core layer 30, and the first metal sheet 20a and the second metal sheet 20b are joined. At this time, the first truss structure body 40 pushes aside the first resin layer 21a and the second resin layer 21b, and comes into contact with the first metal sheet 20a and the second metal sheet 20b. The first resin layer 21a and the second resin layer 21b are combined, and a resin layer 21 formed of a single layer is formed. After that, the resin layer 21 is subjected to cooling or the like to harden the resin layer 21. Thereby, the first truss structure body 40 is joined to the first metal sheet 20a and the second metal sheet 20b. That is, the first resin layer 21a and the second resin layer 21b function as an adhesive. However, from the viewpoint of further ensuring joining strength, a joining method similar to the method of the first embodiment may be further performed. By the above steps, the sandwich metal sheet 15 is fabricated.

### EXAMPLES

### Example 1

### (Fabrication of the Sandwich Metal Sheet)

In Example 1, the first truss structure body 40 and the second truss structure body 50 were fabricated by the following production method. That is, an expanded metal in which a large number of square openings were formed (material: SPCC (JIS G 3141); the thickness of the frame: 0.8 mm) was prepared, and the expanded metal was press-molded with a mold provided with a V-shaped trench; thereby, one row of regular tetragonal pyramidal trusses 40a was fabricated. Then, the expanded metal was press-molded repeatedly with a similar mold, and thereby a first truss structure body 40 in which trusses 40a are arranged in a matrix configuration was produced. Also a second truss structure body 50 having the same structure as the first truss structure body 40 was fabricated by similar steps.

Then, the first truss structure body 40 and the second truss structure body 50 were superimposed so that the vertex 51 of the second truss structure body 50 was placed between vertices 41 of the first truss structure body 40. Specifically, the first truss structure body 40 and the second truss structure body 50 were superimposed so that the top vertex 51a of the second truss structure body 50 was placed at the center between top vertices 41a of the first truss structure body 40 and the bottom vertex 51b of the second truss structure body 50 was placed at the center between bottom vertices 41b of the first truss structure body 40. Thereby, the core layer 30 was fabricated. Subsequently, a plurality of types of cold rolled steel sheets with different thicknesses (metal sheets 20) were prepared, and the metal sheets 20 were used to fabricate a plurality of types of sandwich metal sheets 11 in which the distances W_{L1} and W_{L2} between vertices were 0.35, 0.40, 1.0, 1.4, 1.8, 4.0, and 4.5 times the total thickness of the sandwich metal sheet 11 (Examples). The metal sheets 20 and the core layer 30 were joined by an adhesive (epoxy-based).

In each sandwich metal sheet 11, the thicknesses of the first metal sheet 20a and the second metal sheet 20b were set equal to each other, and the distances W_{L1} and W_{L2} between vertices were set to 10 times the thickness of the metal sheet 20 (i.e. the first metal sheet 20a or the second metal sheet 20b).

### (Folding Test)

A folding test was performed by the following method. Specifically, with the distance between supporting points set to 100 mm, the test piece was pushed in up to 50 mm by a punch 5R. Then, the change in the angle of the top vertex of the truss of the folded portion, that is, the joint angle θ₁₁ was measured by visual inspection. Consequently, it was found that the change in the joint angle θ₁₁ in the case where the distances W_{L1} and W_{L2} between vertices were 0.40, 1.0, 1.4, 1.8, and 4.0 times the total thickness of the sandwich metal sheet 11 was smaller than the change in the joint angle θ₁₁ in the case where the distances W_{L1} and W_{L2} between vertices were 0.35 and 4.5 times the total thickness of the sandwich metal sheet 11. Further, it was found that the change in the joint angle θ₁₁ in the case where the distances W_{L1} and W_{L2} between vertices were 1.0, 1.4, and 1.8 times the total thickness of the sandwich metal sheet 11 was smaller than the change in the joint angle θ₁₁ in the case where the distances W_{L1} and W_{L2} between vertices were 0.40 and 4.0 times the total thickness of the sandwich metal sheet 11.

When the folded portion of each sandwich metal sheet 11 was observed by visual inspection, the caving-in of the metal sheet 20 to the core layer 30 was hardly seen.

Consequently, it has been found that the strength of the folded portion, moldability, and external appearance are improved more when the distances W_{L1} and W_{L2} between vertices are more than or equal to 0.4 times and less than or equal to 4.0 times the total thickness of the sandwich metal sheet 11. It has also been found that the distances W_{L1} and W_{L2} between vertices are more preferably more than or equal to 1.0 time and less than or equal to 1.8 times the total thickness of the sandwich metal sheet 11. It has also been found that the metal sheet 20 hardly caves into the core layer 30 when the distances W_{L1} and W_{L2} between vertices are less than or equal to 10 times the thickness of the metal sheet 20.

Next, as Comparative Example 1, a sandwich metal sheet 100 (Comparative Example 1) in which only the first truss structure body 40 was used for the core layer 30 was fabricated. The distances W_{L1} and W_{L2} between vertices of the sandwich metal sheet 100 were 0.40 times the total thickness of the sandwich metal sheet 100, and were 10 times the thickness of the metal sheet 20 (i.e. the first metal sheet 20a or the second metal sheet 20b). A similar folding test to Example 1 was performed, and it has been found that the change in the joint angle θ₇ of the sandwich metal sheet 100 according to Comparative Example is larger than the change in the joint angle θ₁₁ of each of the sandwich metal sheets 11 according to Example 1, and the metal sheet 20 caves into the core layer 30. From the above results, it has been found that, in the sandwich metal sheet 11 according to Example, the strength of the folded portion, moldability, and external appearance are improved over the sandwich metal sheet 100 according to Comparative Example.

### Example 2

A core layer 30a according to Example 2 was fabricated by joining together the top vertices 41a and 51a of the first truss structure body 40 and the second truss structure body 50 fabricated in Example 1. Subsequently, a plurality of types of cold rolled steel sheets with different thicknesses (metal sheets 20) were prepared, and the metal sheets 20 were used to fabricate a plurality of types of sandwich metal sheets 13 in which the distances W_{L1} and W_{L2} between vertices were 0.35, 0.40, 1.0, 1.4, 1.8, 4.0, and 4.5 times the total thickness of the sandwich metal sheet 13 (Examples). The joining of the metal sheet 20 and the core layer 30a and the joining of the first truss structure body 40 and the second truss structure body 50 were performed by a similar method to Example 1. In each sandwich metal sheet 13, the thicknesses of the first metal sheet 20a and the second metal sheet 20b were set equal to each other, and the distances W_{L1} and W_{L2} between vertices were set to 10 times the thickness of the metal sheet 20 (i.e. the first metal sheet 20a or the second metal sheet 20b).

Next, as a core layer of Comparative Example 2, a truss structure body having a size of the truss of twice the size of the truss 40a was prepared. After that, similar steps to Example 2 were performed; thus, a sandwich metal sheet 100 according to Comparative Example 2 was fabricated. The distances W_{L1} and W_{L2} between vertices of the sandwich metal sheet 100 were 0.40 times the total thickness of the sandwich metal sheet 100, and were 10 times the thickness of the metal sheet 20 (i.e. the first metal sheet 20a or the second metal sheet 20b). A similar folding test to Example 1 was performed on each of the sandwich metal sheets 13 and 100. Consequently, similar results to Example 1 were obtained.

### Example 3

Sandwich metal sheets 11 in which the distances W_{L1} and W_{L2} between vertices were 0.40 times the total thickness of the sandwich metal sheet 11 and were 30 times and 35 times the thickness of the metal sheet 20 (i.e. the first metal sheet 20a or the second metal sheet 20b) were fabricated by a similar production method to Example 1. Then, a similar folding test to Example 1 was performed, and the folded portion was observed by visual inspection. Consequently, when the distances W_{L1} and W_{L2} between vertices were 30 times the thickness of the metal sheet 20, a little caving-in of the metal sheet 20 to the core layer 30 was seen. Further, when the distances W_{L1} and W_{L2} between vertices were 35 times the thickness of the metal sheet 20, further caving-in of the metal sheet 20 to the core layer 30 was seen. Consequently, it has been found that, from the viewpoint of preventing the caving-in of the metal sheet 20, the distances W_{L1} and W_{L2} between vertices are preferably less than or equal to 30 times and more preferably less than or equal to 10 times the thickness of the metal sheet 20. A similar experiment was performed on the sandwich metal sheet 13 of Example 2, and similar results were obtained.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, although in the above embodiments the core layer 30 is fabricated using two bodies of the first truss structure body 40 and the second truss structure body 50, the core layer 30 may be fabricated using three or more truss structure bodies.

### REFERENCE SIGNS LIST

10 sandwich metal sheet
20 metal sheet
20a first metal sheet
20b second metal sheet
21 resin layer
21a first resin layer
21b second resin layer
21c third resin layer
30, 30a core layer
40 first truss structure body
41 vertex
50 second truss structure body
51 vertex

1. A sandwich metal sheet comprising:
a core layer including a first truss structure body and a second truss structure body in which trusses formed of frames are arranged in a matrix configuration;
a first metal sheet provided on one surface of the core layer and joined to at least a vertex of the first truss structure body; and
a second metal sheet provided on another surface of the core layer and joined to at least a vertex of the second truss structure body,
wherein the first truss structure body is joined to at least one of the second truss structure body and the second metal sheet, and
the second truss structure body is joined to at least one of the first truss structure body and the first metal sheet.

2. The sandwich metal sheet according to claim 1, wherein the frame is formed of a metal.

3. The sandwich metal sheet according to claim 2, wherein at least one of the first truss structure body and the second truss structure body is fabricated by molding a metal sheet.

4. The sandwich metal sheet according to claim 3, wherein at least one of the first truss structure body and the second truss structure body is fabricated by molding a punched metal.

5. The sandwich metal sheet according to claim 1, wherein the frame is formed of a resin.

6. The sandwich metal sheet according to claim 1,
wherein vertices of the first truss structure body are joined to the first metal sheet and the second metal sheet, and
vertices of the second truss structure body are joined to the first metal sheet and the second metal sheet, and each of the vertices is placed between vertices of the first truss structure body.

7. The sandwich metal sheet according to claim 6, wherein a vertex of the second truss structure body is placed at a center between vertices of the first truss structure body.

8. The sandwich metal sheet according to claim 6, comprising at least one resin layer formed on at least one of a surface on a side of the core layer of the first metal sheet and a surface on a side of the core layer of the second metal sheet.

9. The sandwich metal sheet according to claim 8, wherein a total thickness of the at least one resin layer substantially coincides with a thickness of the core layer.

10. The sandwich metal sheet according to claim 8, wherein the at least one resin layer is formed of a thermoplastic resin.

11. The sandwich metal sheet according to claim 1,
wherein the second truss structure body is stacked on the first truss structure body, and
a vertex of the first truss structure body and a vertex of the second truss structure body are joined together.

12. The sandwich metal sheet according to claim 11, comprising at least one resin layer formed on at least one of a surface on a side of the core layer of the first metal sheet, a surface on a side of the core layer of the second metal sheet, and a joint portion of the first truss structure body and the second truss structure body.

13. The sandwich metal sheet according to claim 12, wherein a total thickness of the at least one resin layer substantially coincides with a thickness of the core layer.

14. The sandwich metal sheet according to claim 12, wherein the at least one resin layer is formed of a thermoplastic resin.

15. The sandwich metal sheet according to claim 1, wherein at least one of a distance between vertices joined to the first metal sheet and a distance between vertices joined to the second metal sheet is more than or equal to 0.4 times and less than or equal to 4.0 times a total thickness of the sandwich metal sheet.

16. The sandwich metal sheet according to claim 1, wherein at least one of a distance between vertices joined to the first metal sheet and a distance between vertices joined to the second metal sheet satisfies the condition of Mathematical Formula (1) below,
0. 57≦w/h≦3.7/α (1)
where w represents the distance between vertices joined to the first metal sheet or the distance between vertices joined to the second metal sheet,
h represents a distance between the first metal sheet and the second metal sheet, and
α represents a rate of change in a joint angle of the core layer and the first metal sheet or the second metal sheet at a time of folding processing.

17. The sandwich metal sheet according to claim 1, wherein a joint angle of the core layer and the first metal sheet or the second metal sheet is 60 to 150°.

18. A sandwich metal sheet comprising:
a core layer including a truss structure body in which trusses formed of metal frames are arranged in a matrix configuration;
a first metal sheet provided on one surface of the core layer and joined to a first vertex included in the truss structure body;
a second metal sheet provided on another surface of the core layer and joined to a second vertex included in the truss structure body; and
at least one resin layer formed on at least one of a surface on a side of the core layer of the first metal sheet and a surface on a side of the core layer of the second metal sheet.
